(19) United States
(12) Patent Application Publication
(10) Pub. No.: US 2008/0079240 A1
(43) Pub. Date: Apr. 3, 2008

(54) Folding control mechanism for a baby stroller

(75) Inventor: Po-Shiung Yeh, Tainan County (TW)

Correspondence Address: BIRCH STEWART KOLASCH & BIRCH, PO BOX 747, FALLS CHURCH, VA, 22040-0747, US

(73) Assignee: GOLDEN POINT MARKETING LIMITED, Tortola (VG)

(21) Appl. No.: 11/882,757

(22) Filed: Aug. 3, 2007

(30) Foreign Application Priority Data
Sep. 29, 2006 (TW) 095217405

(51) Int. Cl. B62B 7/08

(52) U.S. Cl. 280/642

(57) ABSTRACT

A folding control mechanism for a collapsible baby stroller has a pair of push arms each comprises an upper segment and a lower segment. The upper segment and lower segment both are lockable connected by a pair of first articulated joint. An actuator is mounted for unlock the first articulated joint by pulling a pair of first connecting member, to allow the upper segment capable of pivoting about the first articulated joint to close to the lower segment. A driven ring is installed in the first articulated joint for unlocking the second articulated joints by pulling a pair of a second connecting member while the upper segment of the push arms is rotated about the first articulated joint in a predetermined angle. When the second articulated joint is unlocked, the stroller frame is transferred into a collapsible state.

### BACKGROUND OF THE PRESENT INVENTION

1. Field of the Present Invention

The present invention relates to a collapsible baby stroller and in particular, to a collapsible baby stroller with a pair of foldable and angle adjustable push arms for folding the stroller.

2. Description of the Related Art

Traditional collapsible baby stroller typically can be folded into a compact size for easy transportation and saving store space. However, before doing so, the user or pusher must pull out the passenger baby and hold it with at least one hand, while the passenger baby is too young to stand alone without help. Hence, the folding operation is inconvenience in such a situation.

In order to ease such a situation, U.S. Pat. No. 6,068,284 to Kakuda discloses a collapsible baby stroller that is manually manipulateable with only one hand. The collapsible baby stroller of Kakuda is equipped with a moving member on a gripping portion for controlling a pair of locking device through a pair of wires. As such a moving member is equipped on the gripping portion, the pusher of the stroller may accidentally touch it and cause the stroller become collapsible, and may hurt the baby passenger sitting in there.

### SUMMARY OF THE PRESENT INVENTION

In order to solve the depicted drawback of the prior art, the present invention provides an improved folding control mechanism for a collapsible baby stroller that is safely manipulated by one hand.

The collapsible baby stroller according to the present invention has at least a pair of front wheel struts, a pair of rear wheel struts, a pair of push arms, a pair of second articulated joints controllable connected between the front wheel struts and the push arms. The push arms comprise a gripping portion, an upper segment, a lower segment. The upper segment and lower segment both are lockable connected by a pair of first articulated joint. An actuator is mounted on the gripping portion for unlock the first articulated joint by pulling a pair of first connecting member, to allow the upper segment to pivot about the first articulated joint to close to the lower segment. A driven ring is installed in the first articulated joint for unlocking the second articulated joints by pulling a pair of a second connecting member while the upper segment of the push arms is rotated about the first articulated joint in a predetermined angle. When the second articulated joints are unlocked, the stroller frame is transferred into a collapsible state.

As the folding of the collapsible stroller is now only controlled by pivoting the upper segment of the push arms, the danger of accidently collapsing the stroller shall be avoided.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings, which are given by way of illustration only, and thus are not limitative of the present invention, and wherein:

FIG. 1 is a side view illustrating a collapsible baby stroller frame of an embodiment of the present invention.

FIG. 2 is a side view illustrating a collapsible baby stroller frame of an alternate embodiment of the present invention.

FIG. 3 is an exploded view of the first articulated joint in accordance with the embodiment of the present invention.

FIG. 4 is a side view illustrating the operation of the second articulated joint in accordance with the embodiment of the present invention.

FIG. 5 is a cross-sectional view showing the first articulated joint in a locked position.

FIG. 6 is a cross-sectional view showing an unlocking operation of the first articulated joint from a locked position.

FIG. 7 is a schematic side view showing the folding of the upper segment of the push arms.

FIG. 8 is a cross-sectional view showing the driven ring is driven by the rotation of the upper segment of the push arms, and pulls the second connecting member to unlock the second articulated joint.

FIG. 9 is a schematic diagram showing the collapsible baby stroller frame in fully folded state.

### DETAILED DESCRIPTION OF THE PREFERRED EMBODIMENTS

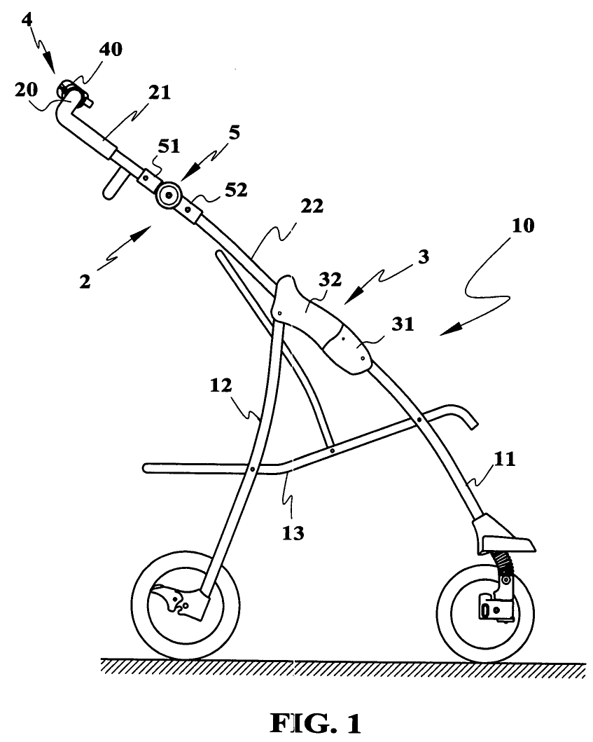

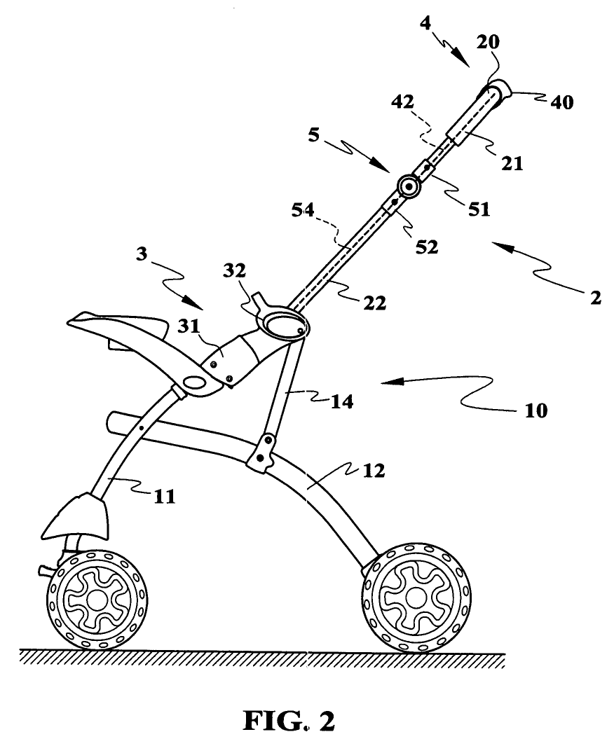

Referring to FIGS. 1 and 2, a folding control mechanism of the present invention can be embodied with a variety of collapsible baby stroller frame 10.

The collapsible baby stroller flame 10 of FIG. 1 has at least a pair of front wheel struts 11, a pair of rear wheel struts 12, a seat support rack 13, a pair of push arms 2, a pair of second articulated joints 3 controllable connected between the front wheel struts 11 and the push arms 2.

Another collapsible baby stroller frame as shown in FIG. 2, has at least a pair of front wheel struts 11, a pair of rear wheel struts 12, a pair of connecting rods 14, a pair of push arms 2, a pair of second articulated joints 3 controllable connected between the front wheel struts 11 and the push arms 2.

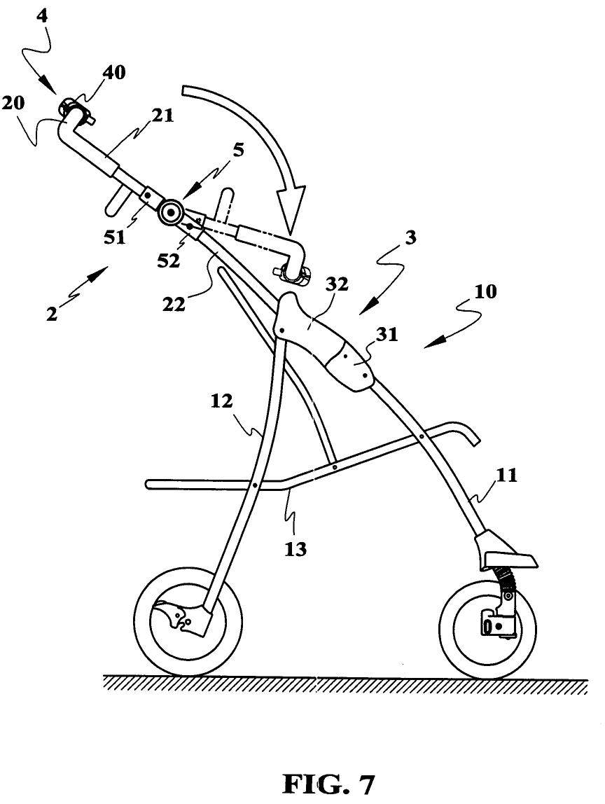

The push arms 2 of the collapsible baby stroller frame 10 as shown in FIGS. 1 and 2 have a same feature of comprising a gripping portion 20, an upper segment 21, and a lower segment 22. The upper segment 21 and the lower segment 22 both are lockable connected by a pair of first articulated joint 5. A first release mechanism 4 is operatively associated with the pair of first articulated joint 5 and includes an actuator 40, a propelling ring 41 and first connecting member 42. The actuator 40 is mounted on the gripping portion 20 for driving the propelling ring 41 to unlock the first articulated joint 5 by pulling the first connecting member 42, so as to allow the upper segment 21 capable of pivoting about the first articulated joint 5 to close to the lower segment 22 as shown in FIG. 7.

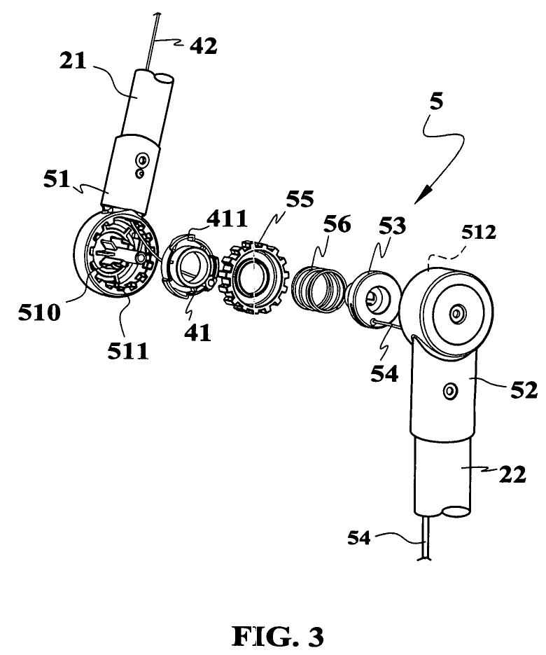

Referring to FIG. 3, the first connecting member 42 is threaded through the upper segment 21 and connected with the propelling ring 41. The propelling ring 41 is coaxially received within the first articulated joint 5 and has a plurality of slopes 411 for slidably connecting and pushing a toothed engaging element 55 while being driven by the first connecting member 42 as will be described in detail below.

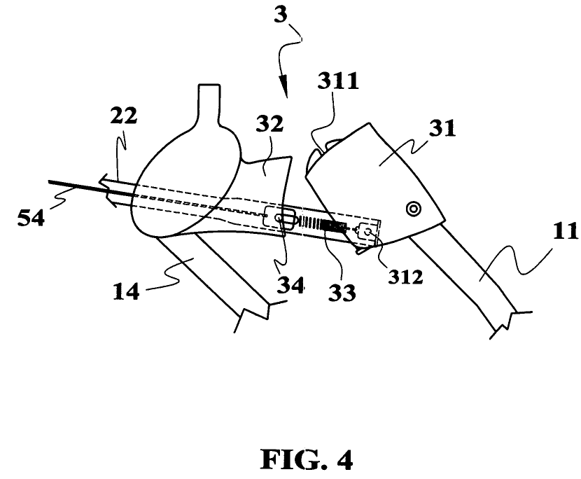

Referring to FIG. 4, the second articulated joint 3 is pivotally connected between the lower segment 22 and the front wheel strut 11.

The second articulated joint 3 has a lower portion 31, an upper portion 32, a biasing element 33 and a latch element 34. The lower portion 31 has one end connected with the front wheel strut 11, an indent 311 for engaging with the latch element 34, and a pivot point 312 for connecting with the distal end of the lower segment 22.

The upper portion 32 is mounted on the lower end of the lower segment 22 and has a portion for pivotally connecting to the rear wheel strut 12 of FIG. 1 or the connecting rod 14 of FIG. 2.

The latch element 34 is slidably received within the lower segment 22 and connected to the driven ring 53 via the second connecting member 54, and has a protruded portion for releasably engaging with the indent 311.

The biasing element 33 is received within the lower segment 22 for forcing the protruded portion of the latch element 34 against the indent 311, so as to keep the second articulated joint 3 in a locked state.

Referring to FIGS. 3, 5 and 6, the first articulated joint 5 has an upper joint member 51, a lower joint member 52, a driven ring 53, a second connecting member 54, a toothed engaging element 55 and a biasing element 56.

The upper joint member 51 is pivotally connected with the lower joint member 52 and formed a receiving space therebetween. The upper joint member 51 has one end connected with the upper segment 21 of push arm 2, an engagable driving portion 510 for engaging and driving the driven ring 53, and a plurality of first inwardly protruded tooth 511 for slidably engaging the toothed engaging element 55.

The lower joint member 52 has one end connected with the lower segment 22 of push arm 2, and a plurality of second inwardly protruded teeth 521 formed at one side thereof. The driven ring 53 is rotatable connected and received within the receiving space. The second connecting member 54 is threaded through the lower joint member 52 and connected between the driven ring 53 and the second articulated joint 3 for controllably unlocking the second articulated joint 3 while being driven by the rotation of the upper segment 21.

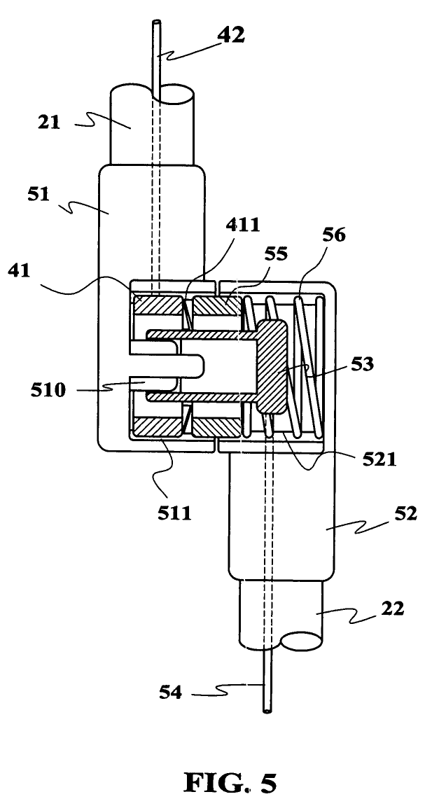

Referring to FIG. 5, the toothed engaging element 55 is slidably engaged with the first inwardly protruded teeth 511 and second inwardly protruded teeth 521 of the upper joint member 51 and the lower joint member 52 in a locked position.

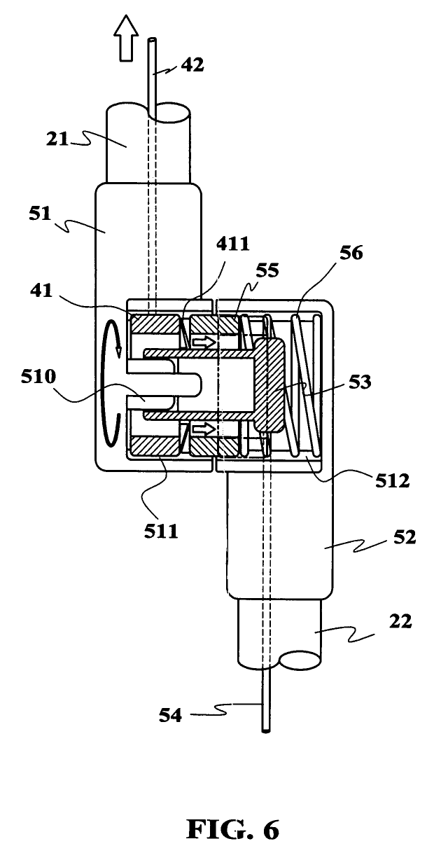

Referring to FIG. 6, when the first release mechanism 4 is manipulated, the propelling ring 41 shall push the toothed engaging element 55 to move and disengage from the first inwardly protruded teeth 511 thereby to unlock the first articulated joint 5.

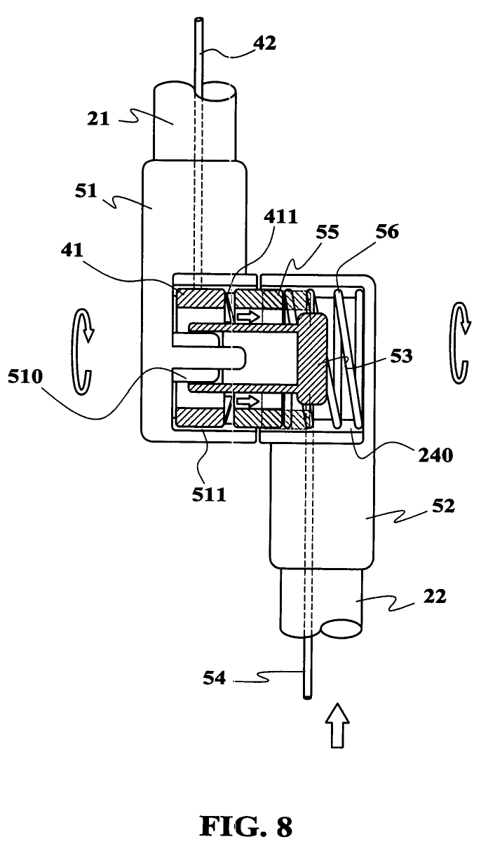

Referring to FIGS. 6 and 8, the biasing element 56 is received within the first articulated joint 5. Preferably, the biasing element 56 may be a compression spring biasing against the toothed engaging element 55 toward the locked position, so as to lock the upper segment 21 in a convenient angle for different pushers while pushing the stroller.

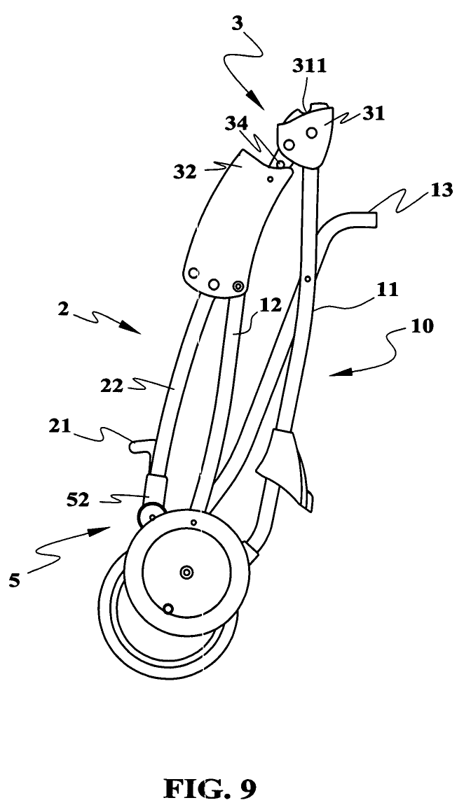

Therefore, the safety of the collapsible stroller according to the present invention is so improved, as the collapsible baby stroller frame 10 is collapsible if only if the upper segment 21 is rotated in a predetermined angle, for instance in an angle between 60 to 180 degrees, that causes the latch element 34 unlocked the second articulated joint 3 as shown in FIG. 7 so as to fold the stroller as shown in FIG. 9.

While the present invention has been described by way of example and in terms of preferred embodiments, it is to be understood that the present invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A folding control mechanism of a baby stroller, the baby stroller comprising:
a pair of push arms, each having a gripping portion, an upper segment and a lower segment;
a pair of first articulated joints, each lockably connected between the upper segment and the lower segment, and having a locked position and an unlocked position;
a first release mechanism operatively connected to the pair of push arms and associated with the pair of first articulated joint for unlocking the pair of first articulated joints from the locked position;
a pair of front wheel struts;
a pair of second articulated joints, each lockably connected between the lower segments and the front wheel struts, and having a locked position and an unlocked position; and
a pair of driving ring, rotatably received within the first articulated joints and driven by a rotation of the upper segment for unlocking the second articulated joints from the locked position via a pair of second connecting member.

2. The folding control mechanism of claim 1, wherein the pair of first articulated joints each has an upper joint member having a plurality of first inwardly protruded teeth, and a lower joint member having a plurality second inwardly protruded teeth, and a toothed engaging element slidably engaged with the first inwardly protruded teeth and the second inwardly protruded teeth in the locked position.

3. The folding control mechanism of claim 2, wherein the upper joint member has an engagable driving portion for engaging and driving the driving ring.

4. The folding control mechanism of claim 2, wherein the pair of second articulated joints is unlocked from the locked position while the upper segments is rotated in an angle between 60 to 180 degrees.

5. The folding control mechanism of claim 2, wherein the first release mechanisms each further comprises a biasing element for keeping the toothed engaging element engaged with the with the first inwardly protruded teeth and the second inwardly protruded teeth in the locked position.

6. The folding control mechanism of claim 2, wherein the first release mechanisms each comprises an actuator mounted on the gripping portion, a propelling ring rotatably received within each of the first articulated joints for pushing the toothed engaging element to disengage from the first inwardly protruded teeth, and a pair of first connecting members connected between the actuator and the propelling ring.

7. The folding control mechanism of claim 5, wherein the biasing element is a compression spring biasing against the toothed engaging element toward the locked position, so as to lock the upper segment in a convenient angle for different pushers for pushing the stroller.

8. The folding control mechanism of claim 6, wherein the propelling ring has a plurality of slopes for slidably contacting and pushing the toothed engaging element to disengage from the first inwardly protruded teeth.

9. The folding control mechanism of claim 1, wherein the pair of second articulated joints, each comprises
a latch element, connected with the driver ring via the second connecting member, and slidably received in the lower segment and having a protruded portion;
a lower portion connected with the front wheel strut, having a pivot point pivotally connected with a distal end of the lower segment, and an indent for detachably engaging with the protruded portion of the latch element;
a biasing element received in the lower segment for keeping the protruded portion to engage with the indent of the lower portion; and
an upper portion connected with the lower segment.

10. The folding control mechanism of claim 9, wherein the baby stroller further comprises:
a rear wheel strut, pivotally connected to the upper portion; and
a seat support rack pivotally connect between the front wheel strut and the rear wheel strut.

11. The folding control mechanism of claim 9, wherein the baby stroller further comprises:
a rear wheel strut, pivotally connected to the front wheel strut; and
a connecting rod pivotally connected between the rear wheel strut and the upper portion.
